(19) United States
(12) Patent Application Publication
(10) Pub. No.: US 2009/0259944 A1
(43) Pub. Date: Oct. 15, 2009

(54) METHODS AND SYSTEMS FOR GENERATING A MEDIA PROGRAM

(75) Inventor: Hsu-Chih WU, Luodong Township (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/255,918

(22) Filed: Oct. 22, 2008

Related U.S. Application Data
(60) Provisional application No. 61/071,062, filed on Apr. 10, 2008.
(60) Provisional application No. 61/071,077, filed on Apr. 11, 2008.

(51) Int. Cl. G06F 3/00

(52) U.S. Cl. 715/738

(57) ABSTRACT

A method for generating a media program includes extracting data from at least one data source, creating at least one program clip using the data, wherein the at least one program clip includes a first media clip, generating at least one data tag corresponding to the program clip using the data, wherein the at least one data tag includes a second media clip, generating a media program, wherein the media program includes the at least one data tag corresponding to the at least one program clip and the at least one program clip, and storing the media program.

### PRIORITY

This application claims the benefit of priority of U.S. Provisional Application No. 61/071,062, filed Apr. 10, 2008, and U.S. Provisional Application No. 61/071,077, filed Apr. 11, 2008, both of which are incorporated by reference herein in their entirety for any purpose.

### TECHNICAL FIELD

The present disclosure relates to the field of media processing and, more particularly, to systems and methods for generating a media program.

### BACKGROUND

Many modern electronic devices such as personal computers and handheld computing devices include software that enables the device to play various types of media. For example, software may enable a computer to play audio or video media content that is accessible via broadcast (e.g., internet streaming or radio) or previously stored (e.g., on a CD, DVD or in an .mp3 file or downloaded content stored on a network).

Software may enable a user to create a playlist of previously stored media content, or list of files to be played in a specified order, according to the user's preferences. However, such playlists can be burdensome to create because it requires the user to spend time organizing and creating the playlists, often from large collections of stored media files. In addition, content for such playlists typically does not include media that is accessible only by broadcast or the latest information such as breaking news. Media received by broadcast also has drawbacks in that a user may have limited to no input into the programming content and may be subjected to content that is not in accordance with the user's preferences.

The disclosed embodiments are directed to overcoming one or more of the problems set forth above.

### SUMMARY OF THE INVENTION

In exemplary embodiments consistent with the present invention, a method is provided for generating a media program. The method extracts data from at least one data source, and creates at least one program clip using the data, wherein the at least one program clip includes a first media clip. The method generates at least one data tag corresponding to the program clip using the data, wherein the at least one data tag includes a second media clip. In addition, the method generates a media program, including the at least one data tag corresponding to the at least one program clip and the at least one program clip, and the method stores the media program.

In exemplary embodiments consistent with the present invention, there is also provided a computing device for generating a media program. The computing device includes at least one memory to store data and instructions and at least one processor configured to access the memory. The at least one processor is configured to, when executing the instructions, extract data from at least one data source. In addition, the at least one processor is configured to, when executing the instructions, create at least one program clip using the data, wherein the at least one program clip includes a first media clip. The at least one processor is further configured to, when executing the instructions, generate at least one data tag corresponding to the program clip using the data, wherein the at least one data tag includes a second media clip. The at least one processor is also configured to, when executing the instructions, generate a media program, including the at least one data tag corresponding to the at least one program clip and the at least one program clip. In addition, the at least one processor is configured to, when executing the instructions, store the media program.

In exemplary embodiments consistent with the present invention, there is further provided a system for generating a media program. The system includes a content extractor module that extracts program clips from one or more data sources. In addition, the system includes a program generator module that organizes the program clips, generates data tags including media clips corresponding to the program clips, and generates a media program that includes the program clips and the corresponding data tags. The system also includes a program pool that stores the media program.

### BRIEF DESCRIPTION OF THE DRAWINGS

FIG. 1 is a block diagram of an exemplary system 100 for generating a media program, consistent with certain disclosed embodiments.

FIG. 2 is a block diagram illustrating an exemplary media program, consistent with certain disclosed embodiments.

FIG. 3 is a block diagram illustrating data extraction using a program content organizer, consistent with certain disclosed embodiments.

FIG. 4 is a simplified illustration of an exemplary program template, consistent with certain disclosed embodiments.

FIG. 5 is a block diagram illustrating a program generator, consistent with certain disclosed embodiments.

FIG. 6 is a block diagram showing creation of a media program consistent with certain disclosed embodiments.

FIG. 7 is a block diagram illustrating personalization of a media program using a navigation manager.

FIG. 8 is a block diagram of an exemplary language learning system consistent with certain disclosed embodiments.

FIG. 9 is a block diagram of an exemplary personal information program consistent with certain disclosed embodiments.

### DETAILED DESCRIPTION

By providing a method and system for generating a media program that includes program clips and data tags corresponding to the program clips, a user may experience a media program having advantageous features of both broadcast media and stored media.

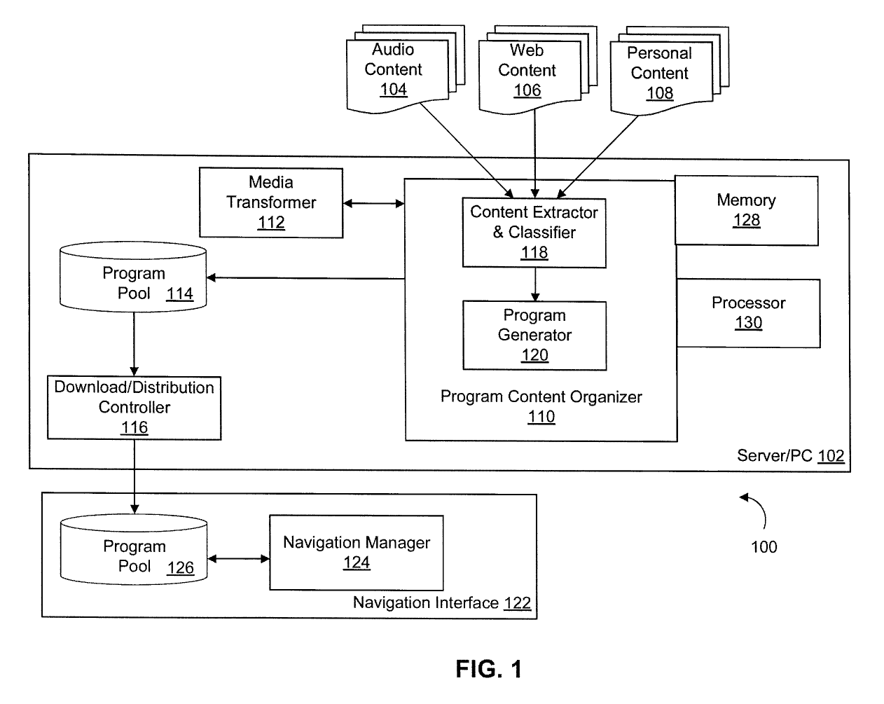

FIG. 1 is a block diagram of an exemplary system 100 for generating a media program, consistent with certain disclosed embodiments. The system 100 includes a computing device such as a server/PC 102, which communicates with data sources to obtain data such as audio content 104, web content 106, and personal content 108. The server/PC 102 includes one or more processors and several modules, including a program content organizer 110, a media transformer 112, an optional program pool 114, and, optionally, a download/distribution controller 116. The program content organizer 110 includes submodules such as a content extractor and classifier 118 and a program generator 120. The server/PC 102 may communicate with a navigation interface 122, which includes several modules including a navigation manager 124 and a program pool 126. One of skill in the art will appreciate that all of the modules of system 100 may reside in a handheld computing device or within a server/PC, or in one embodiment, selected modules of system 100 may reside in server/PC and others may reside in a handheld computing device.

The server/PC 102 may include a memory 128 and a processor 130. Memory 128 may store program modules that, when executed by the processor 130, perform one or more processes for generating a media program. Memory 128 may be one or more memory devices that store data as well as software and may also comprise, for example, one or more of RAM, ROM, magnetic storage, or optical storage. Processor 130 may be provided as one or more processors configured to execute the program modules.

The content extractor and classifier 118 extracts data from a data source. Exemplary data extracted from the data source includes the audio content 104, the web content 106 and/or the personal content 108. Other exemplary data includes database content retrieved from a database, such as a database of material to assist a user in learning a language. The extracted data is used to create a program clip for a media program, the program clip being a media clip that is in a presentation format that a user can view or hear on a media player, such as audio or video. The content extractor and classifier 118 may extract additional data from one or more additional data sources to obtain multiple program clips for one or more media programs. The program generator 120 organizes the playing order of the program clips and generates one or more data tags corresponding to the program clips using the data extracted from the data source, the data tags being text or media clips that are in a presentation format that a user can view or hear on a media player. The program generator 120 then generates a media program that includes program clips and their corresponding data tag or tags. The data tags may include a pre-description, i.e., information corresponding to an associated program clip and designed to precede the program clip in the media program. The data tags may also include a post-description in place of or in addition to the pre-description. The post-description contains information corresponding to an associated program clip and designed to follow the program clip in the media program. The program content organizer 110 may employ the media transformer 112 to transform one or more of the program clip or data tags from a first presentation format to a second presentation format, as described below.

The program generator 120 may store the media program in the program pool 114. The media program may then be accessed by the server/PC 102 or downloaded using the download/distribution controller 116 to a device or module having the navigation interface 122. One of skill in the art will appreciate that the navigation interface 122 may reside in a handheld computing device, a separate server/PC, and/or may alternately reside within the server/PC 102. In one embodiment, the program generator 120 may store the media program in program pool 126 in navigation interface 122.

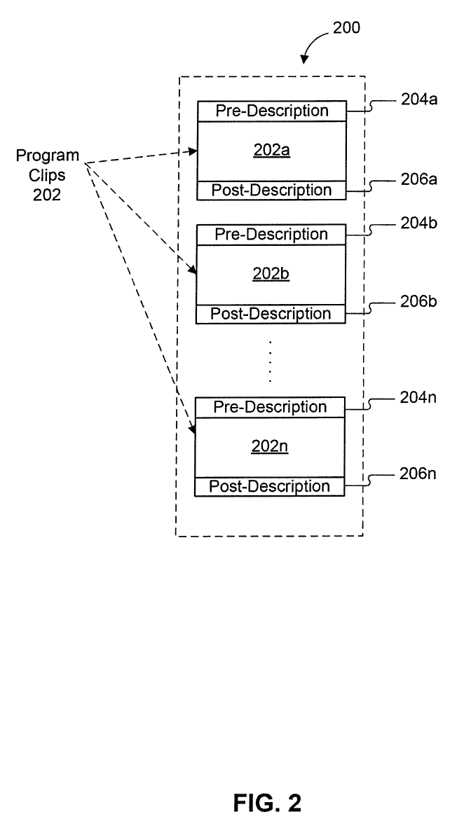

FIG. 2 is a block diagram illustrating an exemplary media program 200 such as may be generated by program generator 120, consistent with certain disclosed embodiments. The media program 200 includes one or more program clips 202, shown as program clip 202a, program clip 202b, . . . , program clip 202n. The media program 200 includes data tags 204, 206 for each of the program clips 202, including pre-descriptions 204a, 204b, . . . , 204n and post-descriptions 206a, 206b, . . . , 206n. When the media program 200 is played, a user will hear/view the pre-description 204a, program clip 202a, and post-description 206a, then hear/view pre-description 204b, program clip 202b, and post-description 206b, followed by subsequent pre-descriptions, clips, and post-descriptions, and concluding with pre-description 204n, program clip 202n, and post-description 206n. In addition, one of skill in the art will appreciate that each of the program clips 202 need not have both a corresponding pre-description 204 and post-description 206. For example, the media program 200 may include the pre-description 204a, the program clip 202a, the program clip 202b, and the post-description 206b. Alternatively, the media program 200 may include only the pre-descriptions 204 or the post-descriptions 206 corresponding to each of the program clips 202.

The data tags 204, 206 may be created using a description generation algorithm which may depend on the particular types of media used in the program clip 202, the data source from which the program clip 202 was retrieved, user preferences, language preferences, etc. The data tags 204, 206 may include commentary retrieved from a website or other data source, or relevant introductory or concluding statements, or a combination thereof. For example, a pre-description for all .mp3 files may be “You're about to hear <<song title>> by <<artist>>,” where the information within arrows (<<>>) is content/user/program specific information to be determined by a clip content analyzer, as discussed below. The description generation algorithm may be modified depending upon user preferences and may be modified depending on the location of the corresponding program clip within the media program. For example, an .mp3 file at the beginning of a media program may have a pre-description “First, let's enjoy the song <<song title>> by <<artist>>,” whereas during the middle of the media program the pre-description may be “Next, I'll bring you <<artist>>'s song, <<song title>>,” and at the end of the media program, the pre-description may be “At last, let's enjoy the song <<song title>>, from <<artist>>.” In addition to using content/user/program specific information, the data tags may use or include data received from user or system preferences or user queries. For example, upon set-up a user may enter the user's birthday and name (<<user name>>), and on that date the description generation algorithm may modify one or more data tags to say “Happy Birthday, <<user name>>!”

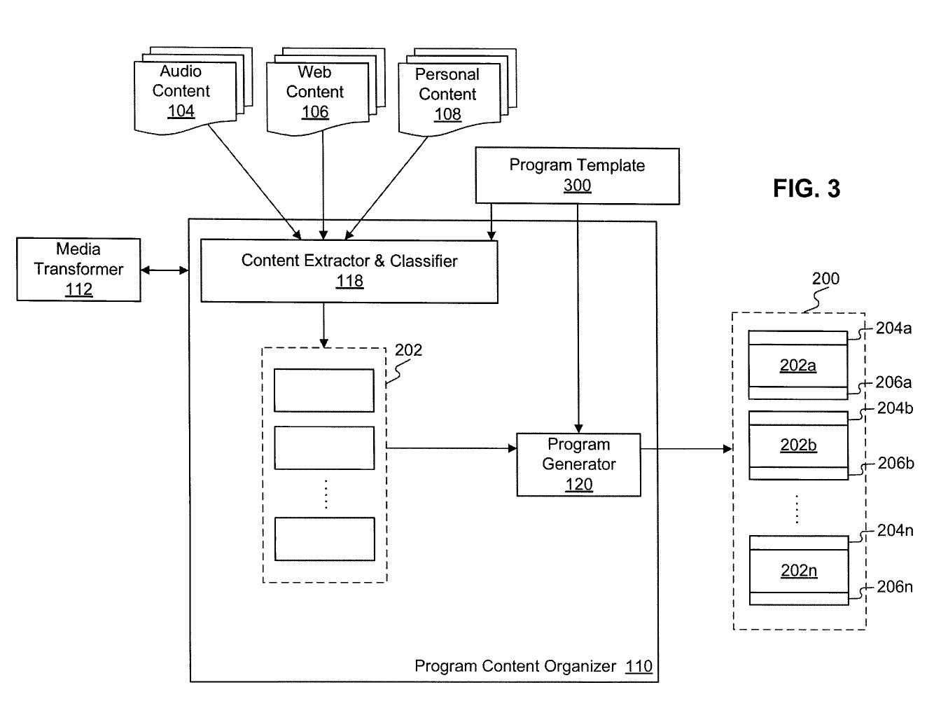

FIG. 3 is a block diagram illustrating data extraction using the program content organizer 110 to generate one or more program clips 202 for media program 200, consistent with certain disclosed embodiments. The content extractor and classifier 118 communicates with data sources and extracts data such as the audio content 104, the web content 106, and/or the personal content 108. Data may be obtained from any source of text, audio, and/or video data such as, but not limited to, Internet websites, media databases stored locally or on a network, e-mail servers, or calendar programs. Content extractor and classifier 118 may employ a program template 300, user input, or system input to obtain guidelines or rules for what data should be extracted and/or what data source or sources should be accessed by the content extractor and classifier 118. The content extractor and classifier 118 extracts data from one or more additional data sources to create one or more program clips 202. In one embodiment, the content extractor and classifier 118 extracts specific portions of data from a data source to create the program clip 202. For example, the content extractor and classifier 118 may extract only an e-mail subject, sender, and time and/or date information for each unread e-mail, as opposed to all unread e-mails or all e-mails in a user's e-mail inbox. In other embodiments, the program clip 202 may be an excerpt of the extracted data, a summary of the extracted data, or indicative of a feature of the extracted data. Content extractor and classifier 118 may employ the program template 300, user input, or system input to obtain guidelines or rules for what information should be included in the program clip 202. The program clip 202 may be transformed into a different presentation format by the media transformer 112 and assembled into the media program 200 by the program generator 120.

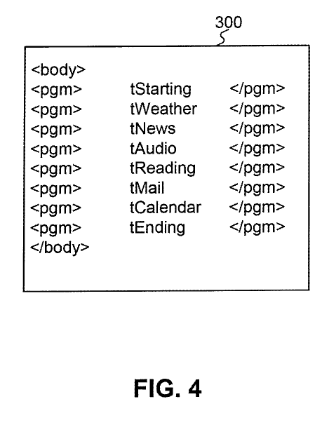

FIG. 4 is a simplified illustration of an exemplary program template 300, consistent with certain disclosed embodiments. Program template 300 includes template instructions and user and system preference data. In FIG. 4, “tStarting” represents a template instruction for a starting program clip, “tWeather” represents the template instruction for a weather information program clip, “tNews” represents the template instruction for a news program clip, “tAudio,” or “tMusic,” represents the template instruction for an audio, video, or music clip, “tReading” represents the template instruction for a text clip that includes, for example, reading material for a language learning program, “tMail” represents the template instruction for an e-mail clip, “tCalendar” represents the template instruction for a calendar program clip, and “tEnding” represents the template instruction for an ending program clip. One of skill in the art will appreciate that the order of exemplary template instructions in program template 300 can be modified according to user or system preferences. The template instructions can provide the content extractor and classifier 118 with instructions about actions to take for a particular type of program clip 202 or particular data sources to access. For example, tWeather may contain instructions for retrieving weather information relating to the user's location from The Weather Channel® at the website weather.com®, tNews may contain instructions for retrieving weather information from cnn.com, tMusic may contain instructions for retrieving an .mp3 file from a user or server music database, and tCalendar may contain instructions for retrieving a personal calendar information from a user's personal profile. One of skill in the art will appreciate that the template instructions shown in FIG. 4 may refer to alternative data sources and that additional template instructions may be utilized by the program template 300.

The program template 300 may include user or system preference data that has been previously provided to the system 100 or determined at the time of data extraction. One example of system preference data that may be included in program template 300 is data relating to mobile device storage capacity. In some embodiments, the content extractor and classifier 118 and/or the program generator 120 may access the system preference data and use this data when performing their respective tasks of extracting information and/or generating media programs. For example, if program template 300 includes system preference data that indicates that there is limited available memory on a mobile device, program generator 120 may generate data tags of shorter duration or in a format that otherwise consumes less memory (e.g., by using audio clips or text clips as opposed to video clips), may generate media programs of shorter duration by including fewer or shorter program clips, or may otherwise generate media programs in a format that consumes less memory. Similarly, content extractor and classifier 118 may extract smaller program clips or clips in a format that consumes less memory. If program template 300 includes system preference data that indicates that there is a large amount of available memory on a mobile device, program generator 120 may generate data tags of longer duration or in a format that otherwise consumes more memory (e.g., by using video clips), may generate media programs of longer duration by including more or longer program clips, or may otherwise generate media programs in a format that consumes more memory. Similarly, content extractor and classifier 118 may extract longer program clips or clips in a format that consumes more memory.

In some embodiments, a user may update the program template 300 to provide user preference data. For example, a user may update the program template 300 to indicate that the user prefers sports news instead of political news. In addition, the content extractor and classifier 118 may obtain and employ additional information or rules other than that included in the program template 300. For example, the content extractor and classifier 118 may retrieve the user's location by accessing a network, the Internet, or other location finder tool, or by querying the user. The content extractor and classifier 118 can then employ the user's location when extracting information such as the weather or local news.

The content extractor and classifier 118 can establish content extraction rules using both the program template 300 and additional obtained data. Exemplary content extraction rules may obtain all (or a restricted number of) data from a particular data source highlighting a particular keyword or obtain all (or a restricted number of) data from a particular data source as restricted by a user's input parameter. For example, a content extraction rule may extract all articles from cnn.com posted today where the headline contains the word “Washington.” The user may input the keyword “Washington” and the date while the program template 300 may specify that cnn.com will be the accessed data source.

In addition, data sources themselves may provide guidelines for data extraction. For example, Really Simple Syndication (RSS) feeds such as those used for news feeds are often categorized into topics (e.g., Business, Education, Health, and World), and a user may select which category of news the user would like to receive. Some program template 300 instructions may require interfacing with and obtaining data from multiple data sources. For example, the template instruction tNews may access Google™ Reader, which may retrieve RSS feeds from multiple news outlets.

Some data sources provide Application Programming Interfaces (APIs) for allowing computing devices to retrieve information from them. For example, weather.com® provides an API to allow users to retrieve weather information given location information, and Google™ Calendar provides an API to allow a computing device to obtain calendar information given a username and user password, which can be stored in user preference information in the system 100.

Data extraction may be user-specific or common to multiple users. In other words, the content extractor and classifier 118 may use the program template 300 or other user preference input means to extract the program clips 202 specific to a particular user. The content extractor and classifier 118 may also extract common data for multiple users and/or create program clips for multiple users. For example, a system designer can generate guidelines instructing the content extractor and classifier 118 to extract data of interest to multiple users, such as common news from a news data source, or a most popular song or popular song playlist from a shared media database. The common data may then be provided to multiple users or included in multiple media programs.

Referring back to FIG. 3, the program content organizer 110 and its content extractor and classifier 118 may communicate with the media transformer 112. The media transformer 112 may transform a portion of the data and/or a portion of the data tags 204, 206 from a first presentation format into a second presentation format. For example, the media transformer 112 may receive text data extracted by the content extractor and classifier 118, such as an e-mail message extracted from a user's e-mail inbox. The media transformer 112 may then transform the text data into audio data using a Text-To-Speech (TTS) module or software. In one embodiment, the media transformer 112 may transform text data or audio data into video data. For example, the media transformer 112 may include a human face synthesis module and, given input data such as text data, the human face synthesis module may create a video clip that shows a human face with his/her mouth moving as if speaking the input text. When combined with a TTS module to transform the text to audio, the media transformer 112 can thereby create a video clip that looks and sounds as if the human face is speaking. One having skill in the art will appreciate that the media transformer 112 may transform data 202 and/or the data tags 204, 206 to and from text, audio, video, or other presentation formats. In one embodiment, the media transformer 112 may transform the entire media program 200 into a different presentation format.

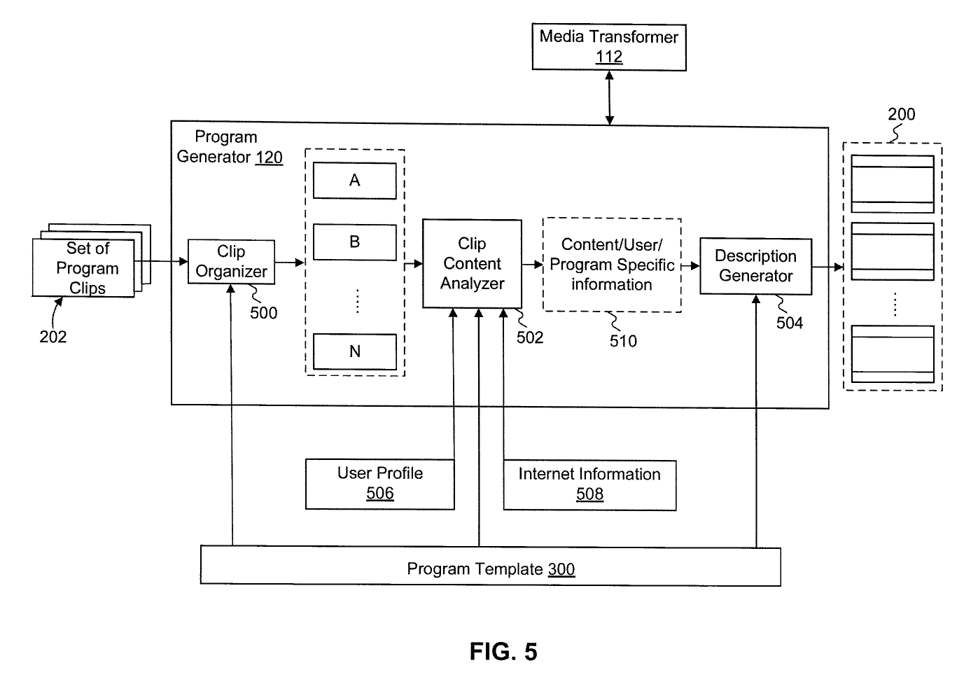

FIG. 5 is a block diagram illustrating the program generator 120, consistent with certain disclosed embodiments. The program generator 120 may include submodules such as a clip organizer 500, a clip content analyzer 502 and a description generator 504. The program generator 120 may also communicate with the program template 300 and be coupled to receive a user profile 506 and internet information 508. The program generator receives the program clips 202a, 202b, . . . , 202n from the content extractor and classifier 118. The clip organizer 500 organizes the program clips 202a, 202b, . . . , 202n into a playing order. The clip organizer 500 may employ the program template 300, user input, or system input to obtain guidelines or rules for how the program clips 202a, 202b, . . . , 202n should be organized. If the program template 300 is formatted as shown in FIG. 4, the clip organizer 500 utilizes the order of the template instructions shown in FIG. 4 to create the playing order. One of skill in the art will appreciate that this order can be modified according to user or system preferences.

The clip content analyzer 502 receives the program clips 202a, 202b, . . . , 202n in the playing order, analyzes the program clips 202a, 202b, . . . , 202n and determines or generates content/user/program specific information 510 corresponding to each program clip 202a, 202b, . . . , 202n. One of skill in the art will appreciate that the clip content analyzer 502 may alternatively receive the set of program clips 202a, 202b, . . . , 202n directly from the content extractor and classifier 118. The content/user/program specific information 510 may be information corresponding to the content of the program clip, information relating to a user's particular preferences, or information relating to the particular type of media program used in the program clip. The content/user/program specific information 510 may be extracted from a database or a website such as a comment from a social networking website from another user. For example, if a program clip is a news program clip that includes five pieces of news, the content/user/program specific information 510 may be the number of news items included in the program clip (<<number of news=“5”>>). If the program clip constitutes an audio file of the song “Dancing Queen” by the musical group Abba, the content/user/specific information 510 may be the song title (<<song title=“Dancing Queen”>>) or the artist name (<<artist=“Abba”>>). If a program clip is a string of two unread e-mails retrieved from a data source that is an e-mail server, the content/user/program specific information 510 may be the number of unread e-mails in the program clip (e.g., <<number of unread e-mails=“2”), or e-mail subject, sender, and time and/or date information for each unread e-mail. One of skill in the art will appreciate that the content/user/program specific information 510 is not limited to these examples but may constitute any form of data retrieved from or corresponding to a program clip.

The clip content analyzer 502 may employ the program template 300 to obtain guidelines or rules for how the content/user/program specific information 510 should be determined or what the content/user/program specific information 510 should include. Alternatively, the clip content analyzer 502 may employ the user profile 506, other user specific information, the internet information 508, or other system information to obtain guidelines or rules for how the content/user/program specific information 510 should be determined or what the content/user/program specific information 510 should include. The clip content analyzer 502 may generate or determine the content/user/program specific information 510 based upon the particular form of media that is employed by the program clip 202. For example, if the program clip 202 is music in the form of an .mp3 file, the clip content analyzer 502 may determine the content/user/program specific information 510 is an ID3 tag extracted from the .mp3 file. As a further example, if the program clip 202 is news data, the clip content analyzer 502 may determine the content/user/program specific information 510 is a number of news items that are of interest to a particular user.

The description generator 504 receives the content/user/program specific information 510 and generates data tags using the content/user/program specific information 510. The content/user/program specific information 510 is specific to the content of the program clips 202a, 202b, . . . , 202n and can be used to create data tags such as the pre-descriptions 204a, 204b, . . . , 204n and the post-descriptions 206a, 206b, . . . , 206n. The description generator 504 may employ the program template 300 to obtain guidelines or rules for how to generate the data tags. As discussed above, the data tags 204a, 204b, . . . , 204n, 206a, 206b, . . . , 206n may be created using a description generation algorithm which may depend on the particular types of media used in the program clips 202a, 202b, . . . , 202n, the data source or data sources from which the program clips 202a, 202b, . . . , 202n were retrieved, user preferences, language preferences, etc. The description generation algorithm may be stored in the program template 300 and may be modified by the user or by a system operator or system creator.

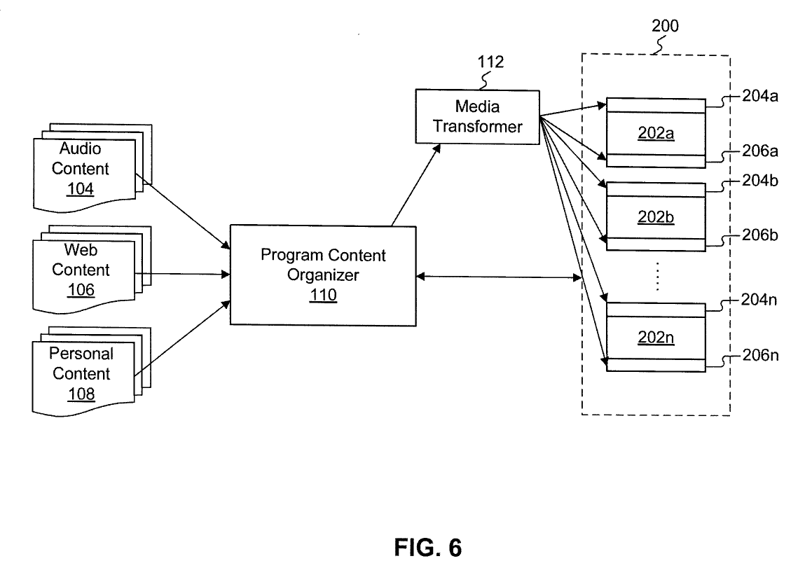

FIG. 6 is a block diagram showing the creation of an exemplary media program 200 consistent with certain disclosed embodiments. The program content organizer 110 may extract the audio content 104, the web content 106, and/or the personal content 108 from data sources using the content extractor and classifier 118 to obtain the program clips 202. The program generator 120 may organize the program clips 202 using the clip organizer 500, and extract the content/user/program specific information 510 corresponding to each program clip 202 using the clip content analyzer 502. For example, if the program clip 202a includes two unread e-mail messages, the content/user/program specific information 510 may be the number of unread e-mails in the program clip (e.g., <<number of unread e-mails=“2”>>). The pre-description 204a for the program clip 202a is “You have two unread e-mails” and the post-description 206a for program clip 204a is “You have no other unread e-mails.” As discussed above, the content extractor and classifier 118 may be set up to extract subject, sender, and time data, to create the program clip 202a itself.

Next, as discussed above, the content/user/program specific information 510 corresponding to the program clip 202b that includes an audio file of the song “Dancing Queen” by the musical group Abba, may be the song title (<<song title=“Dancing Queen”>>), the artist name (<<artist=“Abba”>>), or both. The pre-description 204b for the program clip 202b may be: “Next, let's enjoy the song <<“Dancing Queen”>>by <<“Abba”>>.” The post-description 206b for the program clip 202b may be “Now that's a good song. The Music Hits website said this song is the best song ever.”

Referring also to FIG. 1, the program generator 120 arranges the program clip 202a and the program clip 202b along with the corresponding pre-descriptions 204a, 204b and post-descriptions 206a, 206b to create the media program 200. The program content organizer 110 stores the media program 200 in the program pool 114. Before storing the media program 200, the program generator 120 may communicate the media program 200 to the media transformer 112. The media transformer 112 can then take the text data and convert it to audio data as discussed above, so that the media program 200 is entirely in audio format that, if played, sounds like the following:

“You have two unread e-mails.”
“Regular meeting tomorrow, from Sam Wu, at 8:51 in the morning;
Conference cancelled, from Richard Smith, at 4:12 in the afternoon.”
“You have no other unread e-mails.”
“Next, let's enjoy the song <<“Dancing Queen”>> by <<“Abba”>>.”
(Song plays)
“Now that's a good song. The Music Hits website said this song is the
best song ever.”

With reference to FIG. 1, after the media program 200 has been stored in the program pool 114, it can be played/viewed by a user using the navigation interface 122, which can reside in a handheld or mobile device. The download/distribution controller 116 can temporary link to the navigation manager 124 and download and store the media program 200 into the program pool 126 of the navigation interface 122. The download/distribution controller 116 may regularly perform content broadcasting, and may randomly carry out updates to the media program 200 after the media program 200 has been stored in program pool 126. Alternatively, in one embodiment, the program pool 126 communicates directly with the program pool 114, and the download/distribution controller 116 is not necessary.

After the server/PC 102 and handheld device are disconnected the navigation manager 124 can then access the media program 200 by accessing the program pool 126. In one embodiment, the navigation interface 122 is a module within the server/PC 102, and the navigation manager can then access the media program 200 by accessing the program pool 114. The navigation interface 122 provides user controls such as stop, pause, skip, play, volume, and/or speed controls. When the navigation interface 122 returns from a pause or stop, the system can provide an appropriate pre-description to the remainder of the program clip, such as “Welcome back to the show.” In this manner, the navigation manager 124 provides additional content to the media program 200.

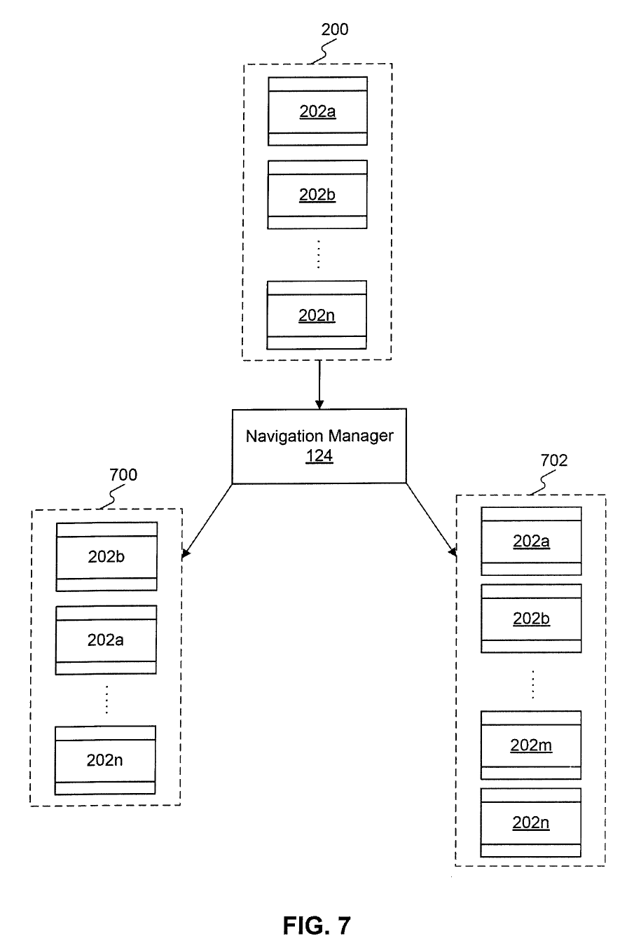

FIG. 7 is a block diagram illustrating personalization of a media program using the navigation manager 124. The navigation manager 124 may allow the user to change the media program 200 stored in the program pool 126 by allowing it to skip program clips 202 or move program clips 202 to different locations within the media program 200 such as to the end of the media program 200. The navigation manager 124 can also store observed user history data and communicate with the program template 300 to edit the program template 300. For example, if the navigation manager 124 observes that the user always skips the program clip 202a until after hearing/viewing the program clip 202b, the navigation manager will edit the program template to create a reordered media program 700, wherein the program clip 202b precedes the program clip 202a. In addition, in some embodiments navigation manager 124 can adapt on the fly to insert new program clips such as an interruption program clip 202m to create a modified media program 702.

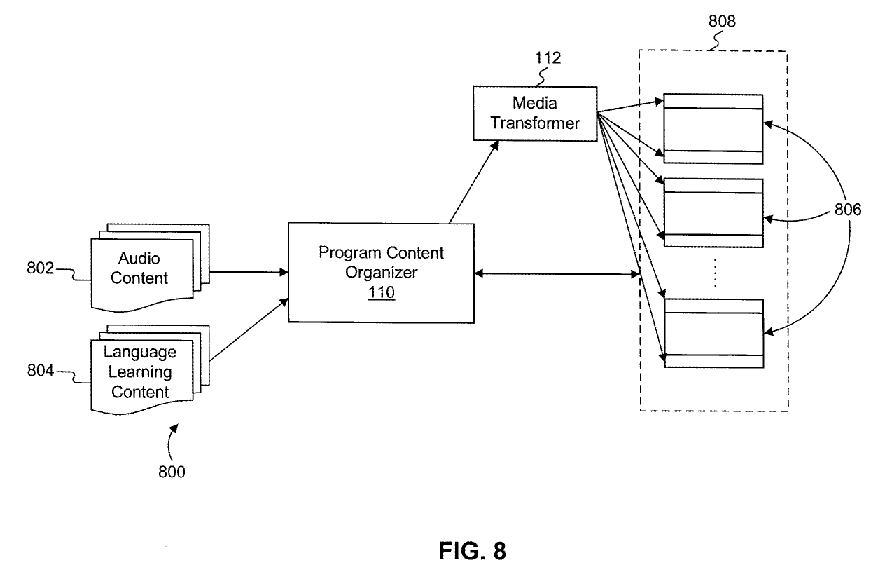

FIG. 8 is a block diagram of an exemplary language learning system 800 consistent with certain disclosed embodiments. In FIG. 8, program content organizer 110 may extract language audio content 802 and language learning content 804 from data sources using the content extractor and classifier 118 to obtain program clips 806. The program generator 120 may organize the program clips 806 using the clip organizer 500, and extract content/user/program specific information 510 corresponding to each program clip 806 using the clip content analyzer 502 to create a language learning media program 808. Exemplary pre-descriptions for the program clips 806 may be hints of important vocabulary or sentence structures in the audio content. Exemplary post-descriptions for the program clips 806 may re-emphasize important vocabulary or sentence structures or provide a quiz for user participation.

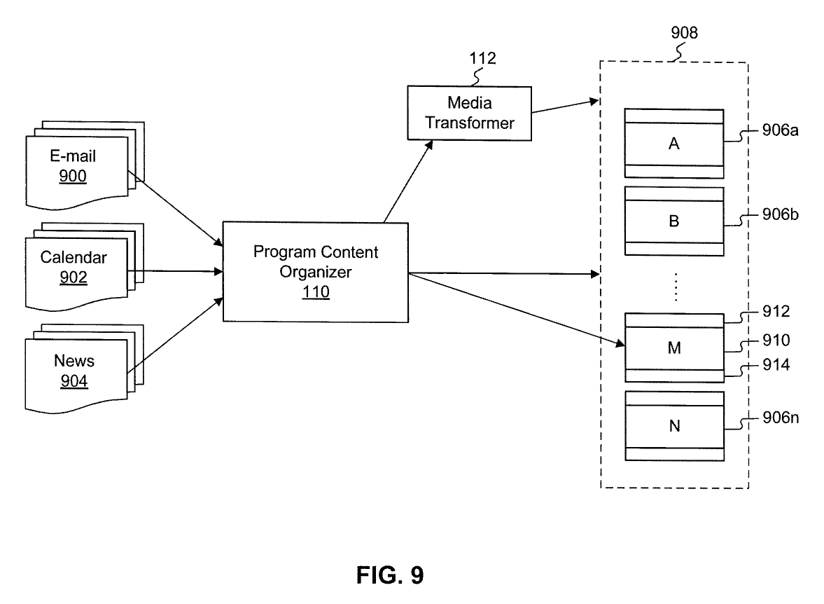

FIG. 9 is a block diagram of an exemplary personal information media program 908 consistent with certain disclosed embodiments. In FIG. 9, the program content organizer 110 may extract e-mails 900, calendar information 902, and news 904 from data sources using the content extractor and classifier 118 to obtain program clips 906. The program generator 120 may organize the program clips 906 using the clip organizer 500, and extract content/user/program specific information 510 corresponding to each of the program clips 906 using the clip content analyzer 502 to create the personal information media program 908. After the playback of the media program 908 has begun, an interruption program clip 910 may be inserted in a relevant location based upon updated information received from the data source such as a new incoming e-mail or incoming critical news update. In addition, a program clip or data tag may itself be interrupted to insert the interruption program clip 910. The interruption program clip 910 may have its own data tags. For example, the interrupt pre-description 912 for the interruption program clip may be “We interrupt your regular program to provide you this important information” and the interrupt post-description may be “Now, back to your regular programming.”

Systems and methods disclosed herein may be implemented in digital electronic circuitry, or in computer hardware, firmware, software, or in combinations of them. Apparatus of the invention can be implemented in a computer program product tangibly embodied in a machine-readable storage device for execution by a programmable processor such as processor 130. Method steps according to the invention can be performed by a programmable processor such as processor 130 executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories such as memory 128. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

It will be apparent to those skilled in the art that various modifications and variations can be made in the methods and systems for generating a media program. It is intended that the standard and examples be considered as exemplary only, with a true scope of the disclosed embodiments being indicated by the following claims and their equivalents.

What is claimed is:

1. A method for generating a media program, comprising:
extracting data from at least one data source;
creating at least one program clip using the data, wherein the at least one program clip includes a first media clip;
generating at least one data tag corresponding to the at least one program clip using the data, wherein the at least one data tag includes a second media clip;
generating a media program, including the at least one data tag corresponding to the at least one program clip and the at least one program clip; and
storing the media program.

2. The method of claim 1, further comprising:
storing preference data in at least one program template; and
employing the at least one program template during at least one of the extracting, the creating, the generating the at least one data tag, and the generating the media program.

3. The method of claim 2, further comprising:
providing a navigation manager with access to the media program for user playback, wherein the navigation manager stores observed user history data; and
modifying the at least one program template using the observed user history data.

4. The method of claim 1, further comprising:
providing a navigation manager with access to the media program for user playback; and
modifying the media program using the navigation manager.

5. The method of claim 1, further comprising:
employing at least one of user input data and system input data during at least one of the extracting, the creating, the generating the at least one data tag, and the generating the media program.

6. The method of claim 1, wherein the generating the at least one data tag comprises generating the at least one data tag to include pre-description or post-description information about the at least one program clip.

7. The method of claim 1, wherein at least one of the creating and the generating the at least one data tag comprises transforming at least a portion of the data from a first presentation format into a second presentation format.

8. A computing device for generating a media program, the computing device comprising:
at least one memory to store data and instructions; and
at least one processor configured to access the memory and configured to, when executing the instructions:
extract data from at least one data source;
create at least one program clip using the data, wherein the at least one program clip includes a first media clip;
generate at least one data tag corresponding to the at least one program clip using the data, wherein the at least one data tag includes a second media clip;
generate a media program, including the at least one data tag corresponding to the at least one program clip and the at least one program clip; and
store the media program.

9. The computing device of claim 8, wherein the processor is further configured to, when executing the instructions:
store preference data in at least one program template; and
employ the at least one program template during at least one of the extracting, the creating, the generating the at least one data tag, and the generating the media program.

10. The computing device of claim 9, wherein the processor is further configured to, when executing the instructions:
provide a navigation manager with access to the media program for user playback, wherein the navigation manager stores observed user history data; and
modify the at least one program template using the observed user history data.

11. The computing device of claim 8, wherein the processor is further configured to, when executing the instructions:
provide a navigation manager with access to the media program for user playback; and
modify the media program using the navigation manager.

12. The computing device of claim 8, wherein the processor is further configured to, when executing the instructions, employ at least one of user input data and system input data during at least one of the extracting, the creating, the generating the at least one data tag, and the generating the media program.

13. The computing device of claim 8, wherein the processor is further configured to, when executing the instructions, generate the at least one data tag to include pre-description or post-description information about the at least one program clip.

14. The computing device of claim 8, wherein the processor is further configured to, when executing the instructions for at least one of the creating and the generating the at least one data tag, transform at least a portion of the data from a first presentation format into a second presentation format.

15. A system for generating a media program, comprising:
a content extractor module that extracts program clips from one or more data sources;
a program generator module that organizes the program clips, generates data tags including media clips corresponding to the program clips, and generates a media program that includes the program clips and the corresponding data tags; and
a program pool that stores the media program.

16. The system of claim 15, further comprising:
a media transformer, for transforming one or more of the program clips from a first presentation format to a second presentation format.

17. The system of claim 15, wherein the program generator module includes:
a clip organizer module that organizes the program clips;
a clip content analyzer module that analyzes the program clips and determines information corresponding to the program clips; and
a description generator module that generates the data tags using the information determined by the clip content analyzer module.

18. The system of claim 15, further comprising a navigation interface that accesses the media program stored in the program pool and facilitates user playback of the media program.

19. The system of claim 18, wherein the content extractor module, the program generator module, the program pool, and the navigation interface reside at a server.

20. The system of claim 18, further comprising:
at least one program template that stores preference data, wherein the at least one program template provides at least one of the content extractor module, the program generator module, and the navigation interface access to the preference data.

21. The system of claim 18, wherein the navigation interface resides in a handheld device.

22. The system of claim 21, further comprising a download/distribution controller for downloading updated media programs to the navigation interface.
